(19) United States
(12) Patent Application Publication
(10) Pub. No.: US 2024/0322259 A1
(43) Pub. Date: Sep. 26, 2024

(54) SHELF STABLE ELECTROLYTE COMPOSITION, POLYMER ELECTROLYTE FREE OF VISIBLE BUBBLES AND SOLID-STATE BATTERIES COMPRISING SAME

(71) Applicant: Factorial Inc., Woburn, MA (US)

(72) Inventors: Zhangxing Shi, Winchester, MA (US); Yiqing Huang, Lexington, MA (US); Jia Du, Burlington, MA (US); Dong Ren, Woburn, MA (US)

(21) Appl. No.: 18/607,649

(22) Filed: Mar. 18, 2024

Related U.S. Application Data
(60) Provisional application No. 63/492,046, filed on Mar. 24, 2023.

(51) Int. Cl. H01M 10/42; H01M 10/0565

(52) U.S. Cl. CPC H01M 10/4235; H01M 10/0565; H01M 2300/0082

(57) ABSTRACT

Disclosed is an electrolyte composition comprising an electrolyte salt, a monomer and an initiator that does not include any groups leading to gas formation during polymerization of the monomer. Also disclosed is an electrolyte composition comprising an electrolyte salt, a monomer and an initiator, wherein the electrolyte composition has a long shelf life. In one embodiment, the electrolyte composition has a viscosity of less than 1000 cP after it is stored 25° C. for 14 days. The disclosure further provides a polymer electrolyte synthesized from the electrolyte composition. In one embodiment, the polymer electrolyte is substantially free of visible bubbles. An electrochemical device comprising the same and preparation method therefor are also disclosed.

### CROSS-REFERENCE

The present application claims priority of U.S. Ser. No. 63/492,046, filed Mar. 24, 2023, the entire content of which is incorporated herein by reference into this application.

### FIELD

This disclosure relates to a shelf stable electrolyte composition, a polymer electrolyte not having visible bubbles, a solid-state battery comprising the same, and a method for preparing the same.

### BACKGROUND

In situ polymerization is widely used for preparing polymer electrolytes. In general, a mixture of monomer, electrolyte salt, solvent, and optional additive is polymerized to convert the monomer into a polymer. To initiate the polymerization, the mixture usually comprises an initiator. Some initiators such as azobisisobutyronitrile (AIBN) are widely used for preparing in situ polymerized polymer electrolytes. However, AIBN generates nitrogen (N₂), which leads to formation of bubbles in the polymer electrolytes. These bubbles could create void spaces, hinder ionic transport, cause inhomogeneity in the electrolyte and on electrode/electrolyte interface, and lead to inhomogeneous deposition of lithium metal and adverse battery performance such as deteriorated cycling performance. In addition, AIBN has poor thermal stability since it decomposes or triggers polymerization at a relatively low temperature (e.g., 30° C.). Thus, a mixture comprising AIBN as initiator normally has a short shelf life and needs to be prepared and used in the same day, which hinders the large-scale manufacturing of the solid-state batteries comprising in situ polymerized polymer electrolytes. Thus, there remains a need for initiators with long shelf life and produce polymer electrolytes free of bubbles, and solid-state batteries comprising the same.

### SUMMARY

The present disclosure provides an in situ polymerized polymer electrolyte free of bubbles and a solid-state battery comprising the same. In one aspect, the polymer electrolyte is prepared by an in situ polymerization in the presence of a bubble-free initiator. In one aspect, the polymer electrolyte is prepared by an in situ polymerization in the absence of bubble-free initiators. In some embodiments, the polymerization is a crosslinking when crosslink points are formed during polymerization and the polymer therein is a crosslinked polymer. Methods for preparing the polymer electrolyte and the solid-state battery are also disclosed.

### BRIEF DESCRIPTION OF THE FIGURES

FIG. 1 shows a representative viscosity change of a mixture comprising a monomer, electrolyte salt, and APS as initiator stored at a temperature of 26.5 and 30.0° C.

FIGS. 2A and 2B show representative pictures of a mixture comprising a monomer, electrolyte salt, and APS as initiator before polymerization and after polymerization, respectively.

FIGS. 3A, 3B and 3C show representative polymer electrolytes obtained by polymerizing a mixture comprising AIBN as initiator at 65° C. for 2 hours, APS as initiator at 75° C. for 2 hours, and APS as initiator at 65° C. for 5 hours, respectively.

FIG. 4 shows the stripping/plating cycles of coin cells comprising Li metal as anode, Cu foil as cathode, microporous membrane as separator, and EL-AIBN, EL-APS, EL-PPS or EL-SPS. EL-AIBN, EL-APS, EL-PPS and EL-SPS refer to polymer electrolytes polymerized with AIBN, APS, PPS, and SPS as initiator, respectively. Only the last few cycles were shown for better comparison.

FIG. 5 shows the specific capacity of coin cells comprising Li metal as anode, NMC811 composite electrode as cathode, microporous membrane as separator, and a polymer electrolyte polymerized in the presence of AIBN, APS or PPS at 65° C. for 2 to 5 hours.

FIG. 6 shows the capacity retention rate of coin cells comprising Li metal as anode, NMC811 composite electrode as cathode, microporous membrane as separator, and a polymer electrolyte polymerized in the presence of AIBN, APS or PPS at 65° C. for 2 to 5 hours.

FIG. 7 shows the specific capacity of pouch cells comprising Li metal as anode, NMC811 composite electrode as cathode, microporous membrane as separator, and a polymer electrolyte polymerized in the presence of AIBN, APS, or PPS at 65° C. for 3 to 5 hours.

FIG. 8 shows the Coulombic efficiency of pouch cells comprising Li metal as anode, NMC811 composite electrode as cathode, microporous membrane as separator, and a polymer electrolyte polymerized in the presence of AIBN, APS, or PPS at 65° C. for 3 to 5 hours.

FIG. 9 shows the capacity retention rate of pouch cells comprising Li metal as anode, NMC811 composite electrode as cathode, microporous membrane as separator, and a polymer electrolyte polymerized in the presence of AIBN, APS, or PPS at 65° C. for 3 to 5 hours.

FIGS. 10A, 10B, and 10C show the existence and formation of bubbles between the separator and the electrode in cells comprising polymer electrolyte polymerized in the presence of AIBN, APS, and PPS, respectively.

FIG. 11 shows the stripping/plating cycles of coin cells comprising Li metal as anode, Cu foil as cathode, microporous membrane as separator, and Electrolyte E and Electrolyte F refer to polymer electrolytes polymerized with AIBN and PPS as initiator, respectively. Only the last cycle was shown for better comparison.

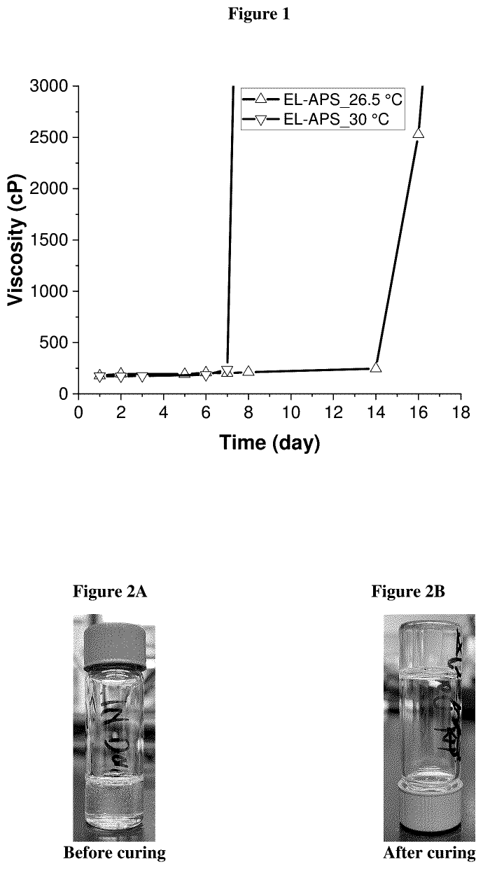

### DETAILED DESCRIPTION

Disclosed herein is an electrolyte composition that is shelf stable for at least 2 days, at least 5 days, at least 7 days, at least 10 days or at least 14 days when stored at 26.5° C. as exhibited by having a viscosity of less than 1000 cP. The electrolyte composition includes an electrolyte salt, a solvent, a monomer, and an initiator. The choice of initiator enables the increased shelf life and also minimizes bubbles in a polymer electrolyte that is formed by polymerizing the monomer in the electrolyte composition. The present disclosure provides an in situ polymerized polymer electrolyte that does not have visible bubbles and a solid-state battery comprising the same. In some embodiments, the polymer electrolyte is substantially free of visible bubbles. In some embodiments, the visible bubbles in the polymer electrolyte have a volume percentage of no more 7.5%, no more than 5%, no more than 4%, no more than 3%, no more than 2.5% or no more than 2% of the polymer electrolyte. In some embodiments, the initiator does not generate gas during polymerization of the monomer, also referred to herein as a non-gas generating initiator or a bubble-free initiator. The electrolyte composition with increased shelf life beyond the 12 to 24 hours of previous electrolyte compositions is a great advantage in being able to prepare the electrolyte composition more than a day in advance of polymerization to form the polymer electrolyte. And the polymer electrolyte having no visible bubbles is advantageous because it avoids or minimizes the formation of void spaces, ensures ionic transport in the polymer electrolyte and on its interface with electrode or separator, facilitates homogeneous deposition of lithium metal, and increases the specific capacity, safety and cycling life of the electrochemical devices.

In one aspect, the polymer electrolyte is prepared by an in situ polymerization in the presence of an initiator that does not generate gas during the polymerization. Such a non-gas generating initiator is an initiator that does not have any groups leading to gas formation during the polymerization. In one aspect, the polymer electrolyte is prepared by an in situ polymerization in the absence of gas-generating initiators, e.g., AIBN.

In some embodiments, the initiator is a persulfate. In some embodiments, a persulfate initiator comprises an anion of SO₅²⁻, S₂O₈²⁻, or both. In some embodiments, non-limiting specific persulfate initiators include ammonium persulfate (APS), potassium persulfate (PPS), sodium persulfate (SPS), lithium persulfate (LPS) and any combination thereof. In some embodiments, the electrolyte composition does not include gas generating initiators, such as azobisisobutyronitrile (AIBN) and benzoyl peroxide (BPO). Examples of gas generating initiators include azo compounds, peroxides, and combinations thereof.

In some embodiments, the mixture contains a bubble-free (or non-gas generating) initiator in an amount from 0.001 wt % to 10 wt %. In some embodiments, the mixture contains a bubble-free initiator in an amount from 0.002 wt % to 10 wt %, from 0.005 wt % to 10 wt %, from 0.01 wt % to 10 wt %, from 0.02 wt % to 10 wt %, from 0.05 wt % to 10 wt %, from 0.1 wt % to 10 wt %, from 0.2 wt % to 10 wt %, from 0.5 wt % to 10 wt %, from 1.0 wt % to 10 wt %, or from 2.0 wt % to 10 wt %. In some embodiments, the mixture contains a bubble-free initiator in an amount from 0.002 wt % to 7.5 wt %, from 0.005 wt % to 7.5 wt %, from 0.01 wt % to 7.5 wt %, from 0.02 wt % to 7.5 wt %, from 0.05 wt % to 7.5 wt %, from 0.1 wt % to 7.5 wt %, from 0.2 wt % to 7.5 wt %, from 0.5 wt % to 7.5 wt %, 1.0 wt % to 7.5 wt %, or 2.0 wt % to 7.5 wt %. In some embodiments, the mixture contains a bubble-free initiator in an amount from 0.005 wt % to 5.0 wt %, from 0.01 wt % to 5.0 wt %, from 0.02 wt % to 5.0 wt %, from 0.05 wt % to 5.0 wt %, from 0.1 wt % to 5.0 wt %, from 0.2 wt % to 5.0 wt %, from 0.5 wt % to 5.0 wt %, 1.0 wt % to 5.0 wt %, or 2.0 wt % to 5.0 wt %. In some embodiments, the mixture contains a bubble-free initiator in an amount from 0.01 wt % to 2.5 wt %, from 0.02 wt % to 2.5 wt %, from 0.05 wt % to 2.5 wt %, from 0.1 wt % to 2.5 wt %, from 0.2 wt % to 2.5 wt %, or from 0.5 wt % to 2.5 wt %. In some embodiments, the mixture contains a bubble-free initiator in an amount from 0.02 wt % to 2.0 wt %, from 0.05 wt % to 2.0 wt %, from 0.1 wt % to 2.0 wt %, from 0.2 wt % to 2.0 wt %, or from 0.5 wt % to 2.0 wt %. In some embodiments, the mixture contains a bubble-free initiator in an amount from 0.05 wt % to 1.5 wt %, from 0.1 wt % to 1.5 wt %, from 0.2 wt % to 1.5 wt %, or from 0.5 wt % to 1.5 wt %.

In some embodiments, the electrolyte salt may be a lithium salt. In certain embodiments, the lithium salt is selected from the group consisting of lithium perchlorate (LiClO₄), lithium hexafluorophosphate (LiPF₆), lithium borofluoride (LiBF₄), lithium hexafluoroarsenide (LiAsF₆), lithium trifluoromethanesulfonate (LiCF₃SO₃), lithium bis(trifluoromethanesulfonyl)imide (LiN(CF₃SO₂)₂, LiTFSI), lithium bis(oxalato)borate (LiBOB), lithium nitrate (LiNO₃), lithium fluoroalkylphosphates (Li[PFₓ(CyF_{2y+1-z}H_{z})₆₋ₓ]) (1≤x≤5, 1≤y≤8, and 0≤z≤2y−1), lithium bis(perfluoroethanesulfonyl)imide (LiBETI), lithium bis(fluorosulfonyl)imide (LiFSI), lithium difluoro(oxalato)borate (LiDFOB), lithium fluorophosphate (Li₂PO₃F), lithium difluoro(bisoxalato)phosphate (LiC₄PO₈F₂), lithium tetrafluoro oxalato phosphate (LiC₂PO₄F₄), lithium difluorophosphate (LiDFP), LiC(CF₃SO₂)₃, LIF, LiCl, LiBr, LiI, Li₂SO₄, Li₃PO₄, Li₂CO₃, LiOH, lithium acetate, lithium trifluoromethyl acetate, lithium oxalate, and a mixture thereof.

In one embodiment, the electrolyte salt has a concentration in a range from 10 wt % to 80 wt % in the mixture. In some embodiments, the electrolyte salt has a concentration in a range from 10 wt % to 75 wt %, from 10 wt % to 70 wt %, from 10 wt % to 65 wt %, from 10 wt % to 60 wt %, from 10 wt % to 55 wt %, from 10 wt % to 50 wt %, from 10 wt % to 45 wt %, from 10 wt % to 40 wt %, from 10 wt % to 35 wt %, from 10 wt % to 30 wt %, or 10 wt % to 25 wt %, in the mixture prior to polymerization. In some embodiments, the electrolyte salt has a concentration in a range from 15 wt % to 80 wt %, from 25 wt % to 80 wt %, from 30 wt % to 80 wt %, from 35 wt % to 80 wt %, from 40 wt % to 80 wt %, from 45 wt % to 80 wt %, from 50 wt % to 80 wt %, from 55 wt % to 80 wt %, from 60 wt % to 80 wt %, from 65 wt % to 80 wt %, or from 70 wt % to 80 wt %, in the mixture prior to polymerization.

In some embodiments, the monomer contains one or more polymerizable groups. In some embodiments, non-limiting specific polymerizable groups include vinyl (—CH═CH₂), substituted vinyl (—CR₁═CR₂R₃) and a combination thereof, wherein R1, R2 and R3 are independently hydrogen, halogen, —CN, —NO₂, C₁₋₆ alkyl, C₁₋₆ haloalkyl, C₁₋₆ hydroxyalkyl, C₁₋₆ aminoalkyl, C₂₋₆ alkenyl, C₂₋₆ alkynyl, C₆₋₁₄ aryl or any combination thereof. Non-limiting specific monomers include 2,2,3,3-tetrafluorobutane-1,4-diacrylate, 2,2,3,3,4,4,5,5-octafluorohexane-1,6-diyl diacrylate, 2,2,3,3,4,4,5,5-octafluorohexane-1,6-diyl bis(2-methylacrylate), poly(ethylene glycol) diacrylate (Mn=700), triethylene glycol dimethacrylate (TEGDMA), diurethane dimethacrylate, and any combination thereof.

In some embodiments, non-limiting monomers are one or more selected from Table 1.

TABLE 1
Monomers for polymer electrolytes.

| Monomer | Structure |
|---|---|
| Tetraallyl silane, TAS | 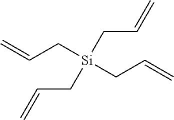 |
| 2,4,6,8-tetramethyl-2,4,6,8- tetravinylcyclotetrasiloxane | 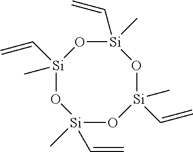 [SMILES: C=C[Si]1(C)O[Si](C)(C=C)O[Si](C)(C=C)O[Si](C)(C=C)O1] |
| Triethoxyvinylsilane | 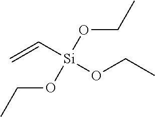 |
| Allyltriethoxysilane | 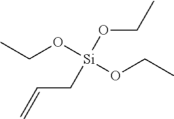 |
| Pentaerythritol tetraacrylate (PETA) | 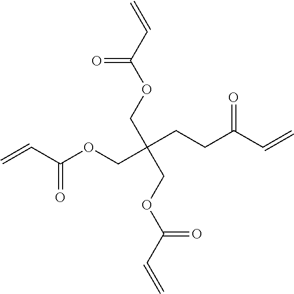 [SMILES: C=CC(=O)CCC(COC(=O)C=C)(COC(=O)C=C)COC(=O)C=C] |
| Pentaerythritol tetramethacrylate (PETMA) | 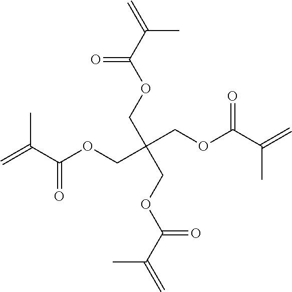 [SMILES: C=C(C)C(=O)OCC(COC(=O)C(=C)C)(COC(=O)C(=C)C)COC(=O)C(=C)C] |
| Tris[2-(acryloyloxy)ethyl] isocyanurate, TAEI | 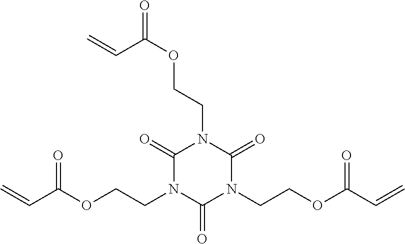 [SMILES: C=CC(=O)OCCn1c(=O)n(CCOC(=O)C=C)c(=O)n(CCOC(=O)C=C)c1=O] |
| Di(trimethylolpropane) tetraacrylate (Di-TMPTA) | 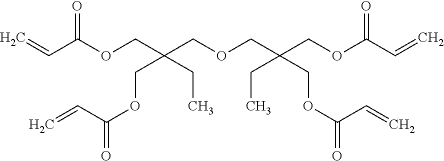 [SMILES: C=CC(=O)OCC(CC)(COCC(CC)(COC(=O)C=C)COC(=O)C=C)COC(=O)C=C] |
| Trimethylolpropane propoxylate triacrylate | 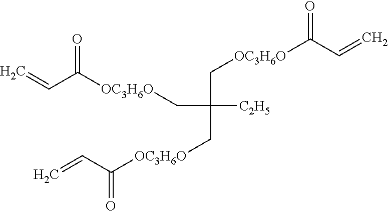 |
| Trimethylolpropane trimethacrylate | 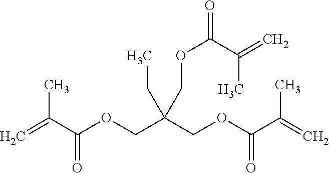 [SMILES: C=C(C)C(=O)OCC(CC)(COC(=O)C(=C)C)COC(=O)C(=C)C] |
| Pentaerythritol triacrylate | 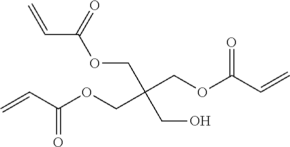 [SMILES: C=CC(=O)OCC(CO)(COC(=O)C=C)COC(=O)C=C] |
| Dipentaerythritol hexaacrylate | 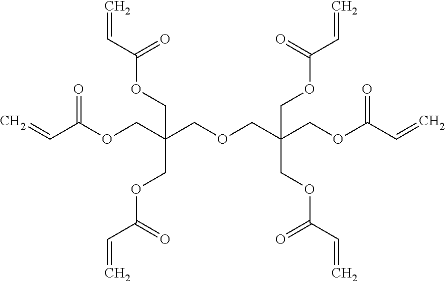 [SMILES: C=CC(=O)OCC(COCC(COC(=O)C=C)(COC(=O)C=C)COC(=O)C=C)(COC(=O)C=C)COC(=O)C=C] |

In some embodiments, the polymer electrolyte is prepared from a mixture containing multiple monomers.

In some embodiments, the mixture for preparing the polymer electrolyte contains a monomer in a range from 0.01 wt % to 50.0 wt %, from 0.02 wt % to 45 wt %, from 0.05 wt % to 40.0 wt %, from 0.1 wt % to 35.0 wt %, from 0.2 wt % to 30.0 wt %, from 0.5 wt % to 25.0 wt %, from 1.0 wt % to 20.0 wt %, from 1.5 wt % to 15.0 wt %, or from 2.0 wt % to 10.0 wt %. In some embodiments, the mixture for preparing the polymer electrolyte contains a monomer in a range from 0.02 wt % to 50.0 wt %, from 0.05 wt % to 50 wt %, from 0.1 wt % to 50.0 wt %, from 0.2 wt % to 50.0 wt %, from 0.5 wt % to 50.0 wt %, from 1.0 wt % to 50.0 wt %, from 2.0 wt % to 50.0 wt %, from 5.0 wt % to 50.0 wt %, or from 10.0 wt % to 50.0 wt %. In some embodiments, the mixture for preparing the polymer electrolyte contains a monomer in a range from 0.02 wt % to 10.0 wt %, from 0.05 wt % to 10 wt %, from 0.1 wt % to 10.0 wt %, from 0.2 wt % to 10.0 wt %, from 0.5 wt % to 10.0 wt %, from 1.0 wt % to 10.0 wt %, from 2.0 wt % to 10.0 wt %, or from 5.0 wt % to 10.0 wt %.

In some embodiments, the mixture comprises a solvent to dissolve Li salts, improve processability, dispersion and/or controlling the ionic conductivity and mechanical strength. In some embodiments, the solvent can be a small molecule (i.e., having a molecular weight of less than 1 kDa), a nitrile, an oligoether, a carbonate, a phosphate, a sulfone, an ester, an ionic liquid, or the like. Examples of the oligoether includes diethyl ether, dimethoxy methane, diethoxy methane, dimethoxy ethane, 1,2-diethoxyethane, 1,1-diethoxyethane, 1,1-dipropoxyethane, 1,2-dipropoxyethane, diethylene glycol, 2-(2-ethoxyethoxy)ethanol, diethylene glycol dimethyl ether, diethylene glycol diethyl ether, diethylene glycol dibutyl ether, triethylene glycol, triethylene glycol monomethyl ether, triethylene glycol monoethyl ether, triethylene glycol monobutyl ether, triethylene glycol dimethyl ether, triethylene glycol diethyl ether, triethylene glycol dibutyl ether, tetraethylene glycol, tetraethylene glycol monomethyl ether, tetraethylene glycol monoethyl ether, tetraethylene glycol monobutyl ether, tetraethylene glycol dimethyl ether, tetraethylene glycol diethyl ether, tetraethylene glycol dibutyl ether, tetrahydrofuran, dioxolane, tetrahydropyran, 1,4-dioxane, 1,3-dioxane, or the like.

Non-limiting examples of other solvents include ethylene carbonate, diethyl carbonate, dimethyl carbonate, ethyl methyl carbonate, propylene carbonate, fluoroethylene carbonate, vinylene carbonate, succinonitrile, glutaronitrile, hexanenitrile, malononitrile, dimethyl sulfoxide, 1,3-propane sultone, sulfolane, dimethyl sulfone, ethyl methyl sulfone, ethyl vinyl sulfone, vinyl sulfone, methyl vinyl sulfone, phenyl vinyl sulfone, N-propyl-N-methylpyrrolidinium bis(fluorosulfonyl)imide, N-butyl-N-methylpyrrolidinium bis(fluorosulfonyl)imide, N-propyl-N-methylpiperidinium bis(fluorosulfonyl)imide, 1-methyl-1-(2-methoxyethyl)pyrrolidinium bis(fluorosulfonyl)imide, 1-ethyl-3-methylimidazolium bis(fluorosulfonyl)imide, trimethyl phosphate, triethyl phosphate, poly(ethylene oxide), or any combination thereof.

In some embodiments, the mixture comprises a solvent at a weight percentage from 5 wt % to 85 wt %, from 5 wt % to 80 wt %, from 5 wt % to 75 wt %, 5 wt % to 70 wt %, 5 wt % to 65 wt %, 5 wt % to 60 wt %, 5 wt % to 55 wt %, 5 wt % to 50 wt %, 5 wt % to 45 wt %, 5 wt % to 40 wt %, 5 wt % to 35 wt %, 5 wt % to 30 wt %, from 5 wt % to 25 wt %, or from 5 wt % to 20 wt % based on the total weight of the mixture for synthesizing the polymer electrolyte. In some embodiments, the mixture comprises a solvent at a weight percentage from 10 wt % to 85 wt %, from 15 wt % to 85 wt %, from 20 wt % to 85 wt %, 25 wt % to 85 wt %, 30 wt % to 85 wt %, 35 wt % to 85 wt %, 40 wt % to 85 wt %, 45 wt % to 85 wt %, 50 wt % to 85 wt %, 55 wt % to 85 wt %, 60 wt % to 85 wt %, from 65 wt % to 85 wt %, or from 70 wt % to 85 wt % based on the total weight of the mixture. In some embodiments, the mixture comprises a solvent at a weight percentage from 10 wt % to 80 wt %, from 15 wt % to 80 wt %, from 15 wt % to 75 wt %, from 20 wt % to 75 wt %, from 25 wt % to 75 wt %, from 30 wt % to 75 wt %, from 35 wt % to 75 wt %, from 40 wt % to 75 wt %, from 45 wt % to 75 wt %, from 50 wt % to 75 wt %, or from 55 wt % to 75 wt %, based on the total weight of the mixture.

In one aspect, the present disclosure provides a mixture for preparing a bubble-free polymer electrolyte via an in situ polymerization, wherein the mixture contains a bubble free (or non-gas generating) initiator. In some embodiments, the mixture exhibits a shelf life of at least 2 days, at least 5 days, at least 7 days, at least 10 days, at least 14 days, or at least 20 days at a temperature of 26.5° C. wherein the electrolyte composition or mixture has a suitable shelf life if it still has a dynamic viscosity of 1000 cp or less upon storage at 26.5° C., wherein the dynamic viscosity is measured on a rotational viscometer at a speed in a range from 5 to 250 rpm. In some embodiments, the mixture with a relatively long shelf life would allow other parts such as the electrode and separator to be fully wetted prior to polymerization. In some embodiments, the mixture comprising the bubble-free (or non-gas generating) initiator avoids or reduces the bubble formation on the electrode/electrolyte interface or electrolyte/separator interface.

In one aspect, the present disclosure provides a method for preparing a polymer electrolyte. In some embodiment, the method comprises: mixing an electrolyte salt, a solvent, a monomer and an initiator into a mixture, wherein the initiator does not form bubbles upon heating, and polymerizing the mixture at an elevated temperature, transforming the monomer in the mixture into a polymer, thus obtaining a polymer electrolyte that contains no visible bubbles or bubbles with a volume percentage of no more than 5% of the polymer electrolyte. A polymer electrolyte is considered substantially free of visible bubbles if it contains no visible bubbles or bubbles with a volume percentage of no more than 5% of the polymer electrolyte. Visible bubbles refer to bubbles observable by the eye without magnification. In some embodiments, the polymer electrolyte has no visible bubbles.

In one aspect, the present disclosure provides an electrochemical device such as solid-state battery comprising the polymer electrolyte substantially free of bubbles or free of visible bubbles. In some embodiments, the solid-state battery comprises an anode layer, a separator, a cathode layer, a first electrolyte layer located between the anode layer and the separator, and a second electrolyte layer located between the cathode layer and the separator. In some embodiments, either or both of the first and second electrolyte layers are the polymer electrolyte substantially free of bubbles or free of visible bubbles as provided in the present disclosure.

In some embodiments, the electrochemical device has a polymer electrolyte disclosed herein has a cycle life at least 5%, at least 7.5%, at least 10%, at least 12.5%, at least 15%, at least 17.5%, at least 20%, at least 22.5% or at least 25% higher than that of an electrochemical device comprising a polymer electrolyte polymerized with a gas-generating initiator. In some embodiments, the electrochemical device is a coin cell, a pouch cell, or a prismatic cell.

In another aspect, the present disclosure provides a method for preparing an electrochemical device comprising a polymer electrolyte substantially free of bubbles or free of visible bubbles. In some embodiments, the electrochemical device comprises an anode layer, a separator, a cathode layer, a first electrolyte layer located between the anode layer and the separator, and a second electrolyte layer located between the cathode layer and the separator. In some embodiments, the method comprises:
a) mixing an electrolyte salt, a solvent, a monomer and an initiator into a mixture, wherein the initiator does not form bubbles upon heating,
b) placing the mixture into the space between the anode layer and the separator and the space between the cathode layer and the separator,
c) allowing the mixture to soak the anode layer, the separator and the cathode, leading to a soaked assembly, and
d) in the soaked assembly, polymerizing the mixture between the anode layer and the separator, and between the cathode layer and the separator into a first and second electrolyte layer, respectively. Thus, obtaining an electrochemical device comprising the anode layer, the separator, the cathode layer, the first electrolyte layer located between the anode layer and the separator, and the second electrolyte layer located between the cathode layer and the separator, wherein the first and second electrolyte layers are substantially free of bubbles or free of visible bubbles.

In some embodiments, the interface between the anode layer and the polymer electrolyte layer has no or substantially reduced visible bubbles. In some embodiments, the interface between the cathode layer and the polymer electrolyte layer has no or substantially reduced visible bubbles. In some embodiments, the interfaces between the separator and the polymer electrolyte layer have no or substantially reduced visible bubbles. In some embodiments, the visible bubbles on the interface cover no more than 12.5%, no more than 10%, no more than 7.5%, no more than 5%, no more than 4%, no more than 3%, no more than 2.5% or no more than 2% of the surface area of the interface. In some embodiments, the separator/electrolyte and/or electrode/electrolyte interfaces are substantially free of big bubbles. In some embodiments, the big bubble refers to a single bubble with a surface area of at least 0.25 cm², at least 0.40 cm², at least 0.50 cm², at least 0.75 cm², or at least 1.00 cm². In some embodiments, the big bubble refers to a single bubble with an area of at least 1.5%, at least 2.0%, at least 2.5%, at least 3.0%, or at least 5% of the total surface area of the interface.

In one embodiment, the interface is substantially free of big bubbles. In one embodiment, the big bubble refers to a single bubble with an area of at least 0.5 cm², at least 2.0% of the surface area of the interface, or both.

In some embodiments, the electrochemical device exhibits a cycle life higher than that of an electrochemical device comprising a polymer electrolyte polymerized with a gas-generating initiator.

In some embodiments, the electrochemical device has a cycle life of at least 5%, at least 7.5%, at least 10%, at least 12.5%, at least 15%, at least 17.5%, at least 20%, at least 22.5%, or at least 25% higher than that of an electrochemical device comprising a polymer electrolyte polymerized with a gas-generating initiator.

In some embodiments, the disclosure provides a method for preparing an electrochemical device comprising an anode layer, a separator, a cathode layer, a first electrolyte layer located between the anode layer and the separator, and a second electrolyte layer located between the cathode layer and the separator, the method comprising:
1) mixing an electrolyte salt, a monomer and an initiator into a mixture, wherein the initiator does not generate gas during polymerization of the monomer;
2) placing the mixture into the space between the anode layer and the separator and the space between the cathode layer and the separator,
3) allowing the mixture to soak the anode layer, the separator and the cathode, resulting in a soaked assembly; and
4) in the soaked assembly, polymerizing the mixture, transforming the mixture between the anode layer and the separator, and between the cathode layer and the separator into a first and second electrolyte layer, respectively. Thus, obtaining an electrochemical device comprising the anode layer, the first electrolyte layer, the separator, the second electrolyte layer, and the cathode layer, the first electrolyte layer located between the anode layer and the separator, and the second electrolyte layer located between the cathode layer and the separator.

The disclosure will be better understood by reference to the Experimental Details which follow, but those skilled in the art will readily appreciate that the specific experiments detailed are only illustrative, and are not meant to limit the disclosure as described herein, which is defined by the claims which follow thereafter.

### Example 1

The shelf life of an electrolyte mixture for in situ synthesis of a polymer electrolyte is critically important. In general, a low viscosity is required so that the electrode and separator surface can be fully wetted with a minimum number of bubbles or voids. The viscosity of the mixture also indicates undesired polymerization during storage. If the mixture's viscosity is too high, the mixture may not infiltrate the electrode or separator surface, which leads to formation of bubbles and/or a large number of voids. The mixture could even turn to a gel during storage, which is no longer suitable for electrolyte filling. Mixtures for in situ synthesizing polymer electrolytes were obtained by adding AIBN, APS or PPS as initiator (0.2 wt % in the mixture) to a base electrolyte composition. The viscosity of the mixture stored at a fixed temperature was measured to characterize the shelf life, which is a period of time at a fixed temperature prior to polymerization. The mixture with AIBN as initiator had a shelf life of only 12 to 24 hours at 26.5° C. Once the mixture is beyond the shelf life, the mixture starts turning into a gel and is unsuitable for preparing polymer electrolyte due to its poor processability. Dynamic viscosity was measured on a rotational viscometer (DV2T Viscometer, Brookfield) at a speed in a range from 5 to 250 rpm. Together with selection of spindle, the testing speed was adjusted so the torque percentage was as high as possible, typically no less than 50%. Table 2 shows the viscosity of the mixture with APS as initiator from day 1 to day 19. Among these measurements, the dynamic viscosity of 2529 cp was measured at a speed of 10 rpm with a torque percentage of 88%. The mixture with APS as initiator had a shelf life of 14 to 16 days at 26.5° C. In general, higher temperature significantly decreases shelf life. Table 3 shows that the mixture with APS as initiator had a shelf life of 7 days at 30° C. It clearly shows that the mixture comprising a bubble free initiator provides a longer shelf life in comparison with bubble-formation initiator. Thus the results show that the electrolyte compositions disclosed herein exhibit a shelf life of at least 2 days, at least 5 days, at least 7 days, at least 10 days, or at least 14 days, at a temperature of 26.5° C. and a dynamic viscosity of 1000 cp or less.

TABLE 2
Viscosity of the mixture with APS as initiator stored at 26.5° C.

| Day | 1 | 2 | 5 | 6 | 7 | 8 | 14 | 16 | 19 |
|---|---|---|---|---|---|---|---|---|---|
| Viscosity/cP | 178 | 196 | 192 | 208 | 202 | 212 | 247 | 2529 | “gel” |

TABLE 3
Viscosity of the mixture with APS as initiator stored at 30° C.

| Day | 1 | 2 | 5 | 6 | 7 | 8 |
|---|---|---|---|---|---|---|
| Viscosity/cP | 174 cP | 172 cP | 176 cP | 186 cP | 238 cP | “gel” |

After a period of 14 days at 26.5° C., the mixture with APS as the initiator was still a clear solution with no precipitates or bubbles (as shown in FIG. 2A) and exhibited a certain fluidity, which indicates a good processability. As also shown in FIG. 2B, the mixture was well polymerized into a clear solid or gel-like electrolyte free of precipitates and bubbles.

The long shelf-life of the polymer electrolyte is crucial for practical applications. If the polymer electrolyte is partially or fully cured before injected into the battery, then it's wasted and could even clog the injection equipment. The electrolyte with AIBN initiator turned cloudy with precipitates after 4 h at room temperature. Electrolyte with APS initiator remained as clear solution after 24 h at room temperature. It demonstrated that a bubble-free initiation system could lead to a longer shelf-life and a better processability.

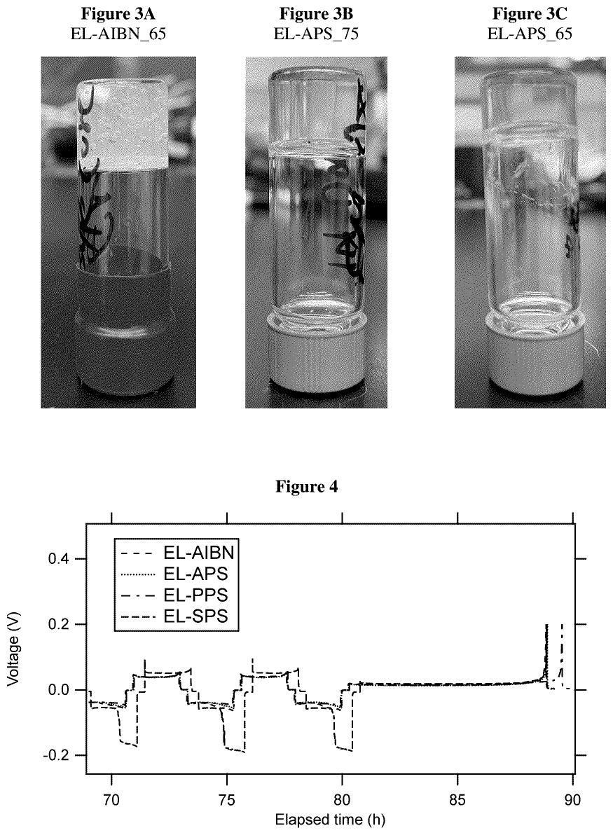

AIBN decomposes to generate radicals as well as nitrogen gas. As verified in FIGS. 3A-3C, bubbles were formed during polymerization of the mixture using AIBN as initiator. In contrast, the bubble-free initiators such as ammonium persulfate (APS) did not form any bubbles in polymer electrolyte by visual inspection.

### Example 2

Li stripping/plating coulombic efficiency (CE) is a critical parameter for the evaluation of electrolyte stability on Li metal anode. The Li stripping/plating CE was obtained by stripping/plating cycles in Li/Cu cells comprising Li metal as anode, Cu foil as cathode, microporous membrane as a separator, and polymer electrolytes prepared from a base electrolyte composition with AIBN, APS, PPS, or SPS added as an initiator. The in situ polymerization of the electrolyte composition was conducted at 65° C. for approximately 2 to 5 hours, leading to polymer electrolytes. As shown in FIG. 4 and Table 4, the polymer electrolytes polymerized with APS and PPS as initiators showed an average CE higher than that of polymer electrolyte polymerized with AIBN. It indicates that the bubble-free polymer electrolytes exhibit a better stability on Li metal electrode.

TABLE 4
Coulombic efficiency (CE) of batteries comprising polymer electrolytes
in situ polymerized in the presence of AIBN, APS, PPS or SPS.

| Initiator | Initial CE, % | Avg. CE, % |
|---|---|---|
| AIBN | 96.23 ± 0.33 | 98.38 ± 0.06 |
| APS | 95.96 ± 0.42 | 98.43 ± 0.11 |
| PPS | 96.06 ± 0.51 | 98.73 ± 0.50 |
| SPS | 96.78 ± 0.85 | 97.73 ± 0.27 |

### Example 3

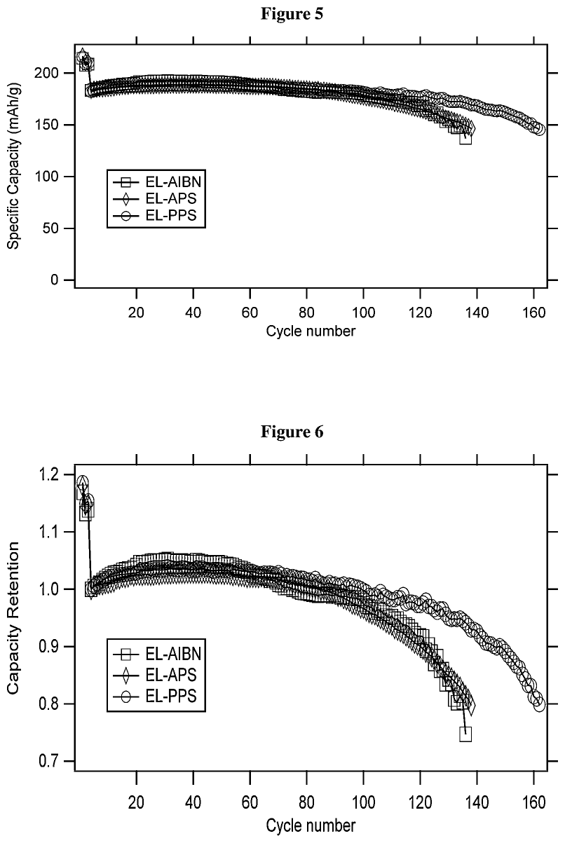

The cycling performance was evaluated in CR2032 type coin cells comprising Li metal as anode, NMC811 composite electrode as cathode, microporous membrane as separator, and polymer electrolytes prepared from a base electrolyte composition with AIBN, APS, or PPS added as an initiator and polymerized at 65° C. for approximately 2 to 5 hours (FIGS. 5 and 6). Cycle life of a cell in the present disclosure refers to the number of cycles that a cell can go before the capacity drops to a level below 80% of the initial capacity. As shown in FIGS. 5 and 6, the polymer electrolyte polymerized with APS showed a cycle life of around 136 cycles which is slightly longer than the one polymerized with AIBN. The polymer electrolyte polymerized with PPS showed a cycle life of 162 cycles, which is 19.1% higher than that of the one polymerized with AIBN.

### Example 4

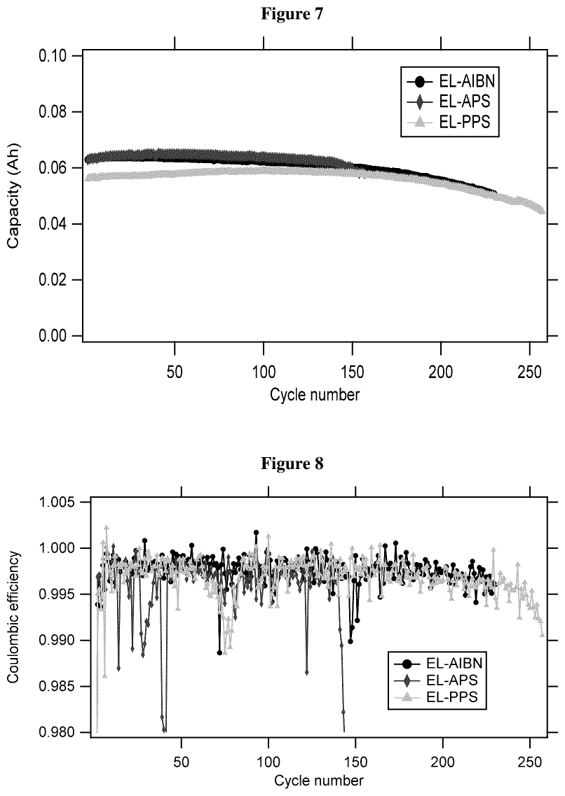

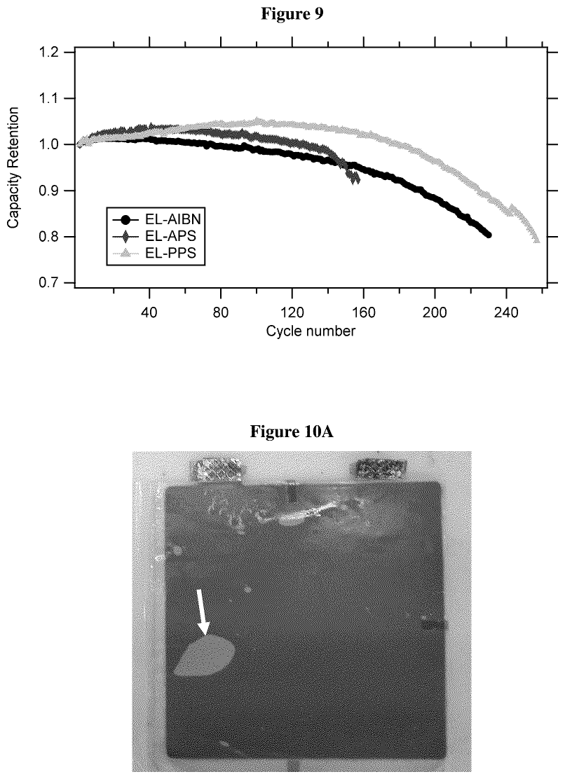

The cycling performance was also evaluated in pouch cells comprising Li metal as anode, NMC811 composite electrode as cathode, microporous membrane as separator, and polymer electrolytes prepared from a base electrolyte composition with AIBN, APS, or PPS added as an initiator and polymerized at 65° C. for 3 to 5 hours (FIGS. 7, 8, and 9). The polymer electrolyte polymerized with APS showed a capacity retention rate higher than the electrolyte polymerized with AIBN up to 140 cycles. The projected cycle life of APS electrolyte is longer than that of polymer electrolyte prepared with AIBN. Polymer electrolyte polymerized with PPS showed the longest cycle life. As shown in FIGS. 7 to 9, the polymer electrolyte polymerized with AIBN showed a cycle life of around 235 cycles while the polymer electrolyte polymerized with PPS showed a cycle life of 258 cycles, which is 9.4% higher than that polymerized with AIBN.

### Example 5

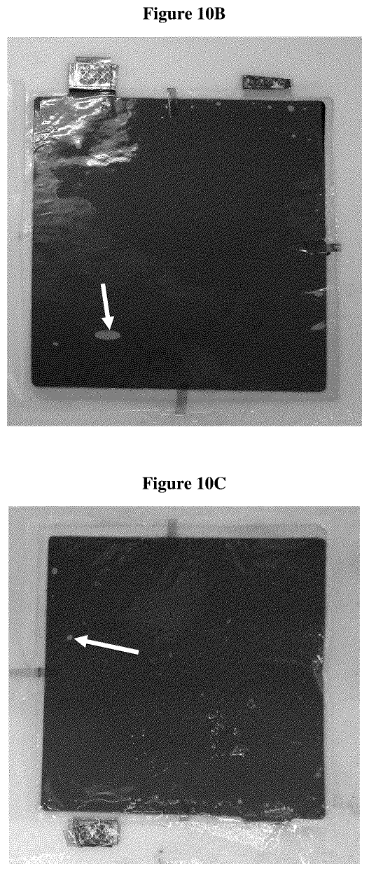

FIGS. 10A-C show the teardown of pouch cells comprising Li metal as anode, NMC811 composite electrode as cathode, microporous membrane as separator, and polymer electrolytes comprising a base electrolyte composition with AIBN, APS, or PPS added as an initiator and polymerized at 65° C. for 3 to 5 hours, respectively. A big bubble (an area of 0.60 cm², 2.4% of the total surface area of the interface) between the separator and electrode was observed in a cell comprising the polymer electrolyte synthesized in the presence of AIBN as initiator. Only very small bubbles (i.e. substantially free of visible bubbles) between the separator and electrode were found in the systems using APS or PPS as initiator. These very small bubbles were generated in the process of pouch cell manufacturing, which is not attributed to the initiator. By utilizing the bubble-free initiators, the number of bubbles found in between the separator and electrode were significantly reduced. Therefore, the transportation of ions in the polymer electrolyte and on its interface with electrode or separator would not be disrupted. Deposition of lithium metal on the anode was homogeneous, which leads to a better safety and cycling performance of the cell.

### Example 6

Electrolyte A was an ionic liquid based electrolyte and prepared with 0.2 wt % AIBN as initiator. Electrolyte B was the same as electrolyte A except it was prepared with 0.2 wt % APS as initiator. Both electrolytes were cured at 65° C. for 2 h. Electrolyte A with AIBN contained lots of bubbles after curing. Electrolyte B with APS contained no visible bubbles.

### Example 7

Electrolyte C was a sulfone based electrolyte and was prepared with 0.2 wt % AIBN as initiator. Electrolyte D was the same as Electrolyte C except that it was prepared with 0.2 wt % APS as initiator. Both electrolytes were cured at 65° C. for 2 h. Electrolyte C with AIBN contained lots of bubbles after curing. Electrolyte D with APS contained no visible bubbles.

### Example 8

Electrolyte E was an ether based electrolyte and was prepared using 0.2 wt % AIBN as initiator. Electrolyte F was the same as electrolyte E except that it was prepared with 0.2 wt % PPS as initiator. Both electrolytes were cured at 65° C. for 2 h. The bubbles formed in electrolyte E were observed while Electrolyte F did not have any visible bubbles.

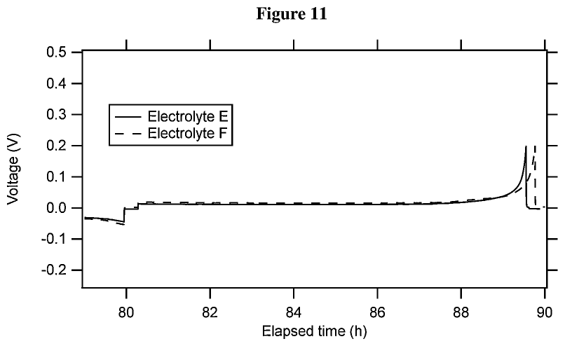

The Li stripping/plating CE was obtained by stripping/plating cycles in Li/Cu cells comprising Li metal as anode, Cu foil as cathode, microporous membrane as a separator, and polymer electrolytes prepared from Electrolyte E and Electrolyte F. The in situ polymerization of the electrolyte composition was conducted at 65° C. for 2 hours, leading to polymer electrolytes. As shown in FIG. 11, the polymer electrolyte polymerized with PPS as initiator showed an average coulombic efficiency (CE) (99.43%) which is higher than that of Electrolyte F (polymer electrolyte polymerized with AIBN) with an average CE of 99.15%. It indicates that the bubble-free polymer electrolytes exhibit a better stability on Li metal electrode.

In a first aspect of the disclosure, an electrolyte composition comprises:
1) an electrolyte salt;
2) a monomer; and
3) an initiator that does not generate gas during polymerization of the monomer.

In a second aspect of the disclosure when the electrolyte composition is stored at 25° C. for 2 days, the electrolyte composition has a dynamic viscosity of less than 1000 cP.

In a third aspect of the disclosure, an electrolyte composition comprises:
1) an electrolyte salt;
2) a monomer; and
3) an initiator,
wherein when the electrolyte composition is stored at 25° C. for 14 days, the electrolyte composition has a dynamic viscosity of less than 1000 cP.

In a fourth aspect of the disclosure, the initiator does not generate gas during polymerization of the monomer.

In a fifth aspect of the disclosure, the initiator is a persulfate.

In a sixth aspect of the disclosure, the initiator is selected from the group consisting of ammonium persulfate (APS), potassium persulfate (PPS), sodium persulfate (SPS), lithium persulfate (LiPS), and any combination thereof.

In a seventh aspect of the disclosure, the initiator has a concentration in a range from 0.001 wt % to 10 wt % in the electrolyte composition.

In an eighth aspect of the disclosure, the monomer has one or more polymerizable groups.

In a ninth aspect of the disclosure, wherein the monomer has at least two or more polymerizable groups.

In a tenth aspect of the disclosure, monomer is selected from the group consisting of 2,2,3,3-tetrafluorobutane-1,4-diacrylate, 2,2,3,3,4,4,5,5-octafluorohexane-1,6-diyl diacrylate, 2,2,3,3,4,4,5,5-octafluorohexane-1,6-diyl bis(2-methylacrylate), poly(ethylene glycol) diacrylate with an Mn in a range from 500 to 5000 Da, triethylene glycol dimethacrylate (TEGDMA), diurethane dimethacrylate, tetraallyl silane (TAS), 2,4,6,8-tetramethyl-2,4,6,8-tetravinylcyclotetrasiloxane, triethoxyvinylsilane, allyltriethoxysilane, pentaerythritol tetraacrylate (PETA), pentaerythritol tetramethacrylate (PETMA), tris[2-(acryloyloxy)ethyl]isocyanurate (TAEI), di(trimethylolpropane) tetraacrylate (Di-TMPTA), trimethylolpropane propoxylate triacrylate, trimethylolpropane trimethacrylate, pentaerythritol triacrylate, dipentaerythritol hexaacrylate, and a combination thereof. In some embodiments, the poly(ethylene glycol) diacrylate has an Mn of 500, 700, 1000, 2000, 5000 or 7000 Da.

In an eleventh aspect of the disclosure, the monomer has a concentration of 0.01 wt % to 50.0 wt % in the electrolyte composition.

In a twelfth aspect of the disclosure, the electrolyte composition does not include any gas-generating initiators.

In a thirteenth aspect of the disclosure, the gas-generating initiators are azo compounds, peroxides, or a combination thereof.

In a fourteenth aspect of the disclosure, the electrolyte salt is selected from the group consisting of lithium perchlorate (LiClO₄), lithium nitrate (LiNO₃), lithium hexafluorophosphate (LiPF₆), lithium borofluoride (LiBF₄), lithium hexafluoroarsenide (LiAsF₆), lithium trifluoromethanesulfonate (LiCF₃SO₃), lithium bis(perfluoroethanesulfonyl)imide (LiBETI), lithium bis(fluorosulfonyl)imide (LiFSI), lithium bis(trifluoromethanesulfonyl)imide (LiN(CF₃SO₂)₂, LiTFSI), lithium bis(oxalato)borate (LiBOB), lithium difluoro(oxalato)borate (LiDFOB), lithium fluoroalkylphosphates (Li[PFₓ(CyF_{2y+1-z}H_{z})₆₋ₓ]) (1≤x≤5, 1≤y≤8, and 0≤z≤2y−1), lithium fluorophosphate (Li₂PO₃F), lithium difluorophosphate (LiDFP), lithium difluoro(bisoxalato)phosphate (LiCAPO₈F₂), lithium tetrafluoro oxalato phosphate (LiC₂PO₄F₄), lithium tris(trifluoromethanesulfonyl)methide (LiC(CF₃SO₂)₃), LiF, LiCl, LiBr, LiI, Li₂SO₄, Li₃PO₄, LizCO₃, LiOH, lithium acetate, lithium trifluoromethyl acetate, lithium oxalate, and a mixture thereof.

In a fifteenth aspect of the disclosure, the electrolyte salt has a concentration in a range from 10 wt % to 80 wt % in the electrolyte composition.

In a sixteenth aspect of the disclosure, the electrolyte composition further comprises an electrolyte solvent, wherein the electrolyte solvent is selected from the group consisting of diethyl ether, dimethoxy methane, diethoxy methane, dimethoxy ethane, 1,2-diethoxyethane, 1,1-diethoxyethane, 1,1-dipropoxyethane, 1,2-dipropoxyethane, diethylene glycol, 2-(2-ethoxyethoxy)ethanol, diethylene glycol dimethyl ether, diethylene glycol diethyl ether, diethylene glycol dibutyl ether, triethylene glycol, triethylene glycol monomethyl ether, triethylene glycol monoethyl ether, triethylene glycol monobutyl ether, triethylene glycol dimethyl ether, triethylene glycol diethyl ether, triethylene glycol dibutyl ether, tetraethylene glycol, tetraethylene glycol monomethyl ether, tetraethylene glycol monoethyl ether, tetraethylene glycol monobutyl ether, tetraethylene glycol dimethyl ether, tetraethylene glycol diethyl ether, tetraethylene glycol dibutyl ether, tetrahydrofuran, dioxolane, tetrahydropyran, 1,4-dioxane, 1,3-dioxane, ethylene carbonate, diethyl carbonate, dimethyl carbonate, ethyl methyl carbonate, propylene carbonate, fluoroethylene carbonate, vinylene carbonate, succinonitrile, glutaronitrile, hexanenitrile, malononitrile, dimethyl sulfoxide, 1,3-propane sultone, sulfolane, dimethyl sulfone, ethyl methyl sulfone, ethyl vinyl sulfone, vinyl sulfone, methyl vinyl sulfone, phenyl vinyl sulfone, N-propyl-N-methylpyrrolidinium bis(fluorosulfonyl)imide, N-butyl-N-methylpyrrolidinium bis(fluorosulfonyl)imide, N-propyl-N-methylpiperidinium bis(fluorosulfonyl)imide, 1-methyl-1-(2-methoxyethyl)pyrrolidinium bis(fluorosulfonyl)imide, 1-ethyl-3-methylimidazolium bis(fluorosulfonyl)imide, trimethyl phosphate, triethyl phosphate, poly(ethylene oxide), and a combination thereof.

In a seventeenth aspect of the disclosure, the electrolyte solvent has a concentration in a range from 5 wt % to 85 wt % in the electrolyte composition.

In an eighteenth aspect of the disclosure, a polymer electrolyte comprises the electrolyte composition wherein the monomer in the electrolyte composition has been polymerized into a polymer.

In a nineteenth aspect of the disclosure, the monomer has more than one polymerizable group and the polymer is a crosslinked polymer.

In a twentieth aspect of the disclosure, the polymer electrolyte contains visible bubbles with a volume percentage of no more than 5% of the polymer electrolyte.

In a twenty first aspect of the disclosure, the polymer electrolyte has no bubbles.

In a twenty second aspect of the disclosure, an electrochemical device comprises the polymer electrolyte as disclosed herein.

In a twenty third aspect of the disclosure, the electrochemical device exhibits a cycle life higher than that of an electrochemical device comprising a polymer electrolyte polymerized with a gas-generating initiator.

In a twenty fourth aspect of the disclosure, the electrochemical device has a cycle life of at least 7.5% higher than that of an electrochemical device comprising a polymer electrolyte polymerized with a gas-generating initiator.

In a twenty fifth aspect of the disclosure, a method for preparing a polymer electrolyte, comprises:
a) mixing an electrolyte salt, a monomer and an initiator into a mixture; and
b) polymerizing the mixture, transforming the monomer in the mixture into a polymer, wherein the initiator does not generate gas during polymerization of the monomer, and wherein upon polymerizing the polymer electrolyte contains visible bubbles with a volume percentage of no more than 5% of the polymer electrolyte.

In a twenty sixth aspect of the disclosure, the polymer electrolyte has no visible bubbles.

What is claimed is:

1. An electrolyte composition comprising:
a) an electrolyte salt;
b) a monomer; and
c) an initiator that does not generate gas during polymerization of the monomer.

2. The electrolyte composition of claim 1, wherein when the electrolyte composition is stored at 25° C. for 2 days, the electrolyte composition has a dynamic viscosity of less than 1000 cP.

3. An electrolyte composition comprising:
a) an electrolyte salt;
b) a monomer; and
c) an initiator,
wherein when the electrolyte composition is stored at 25° C. for 14 days, the electrolyte composition has a dynamic viscosity of less than 1000 cP.

4. The electrolyte composition of claim 3, wherein the initiator does not generate gas during polymerization of the monomer.

5. The electrolyte composition of claim 1, wherein the initiator is a persulfate.

6. The electrolyte composition of claim 1, wherein the initiator is selected from the group consisting of ammonium persulfate (APS), potassium persulfate (PPS), sodium persulfate (SPS), lithium persulfate (LiPS), and any combination thereof.

7. The electrolyte composition of claim 1, wherein the initiator has a concentration in a range from 0.001 wt % to 10 wt % in the electrolyte composition.

8. The electrolyte composition of claim 1, wherein the monomer has one or more polymerizable groups.

9. The electrolyte composition of claim 1, wherein the monomer is selected from the group consisting of 2,2,3,3-tetrafluorobutane-1,4-diacrylate, 2,2,3,3,4,4,5,5-octafluorohexane-1,6-diyl diacrylate, 2,2,3,3,4,4,5,5-octafluorohexane-1,6-diyl bis(2-methylacrylate), poly(ethylene glycol) diacrylate (Mn=700), triethylene glycol dimethacrylate (TEGDMA), diurethane dimethacrylate, tetraallyl silane (TAS), 2,4,6,8-tetramethyl-2,4,6,8-tetravinylcyclotetrasiloxane, triethoxyvinylsilane, allyltriethoxysilane, pentaerythritol tetraacrylate (PETA), pentaerythritol tetramethacrylate (PETMA), tris[2-(acryloyloxy)ethyl]isocyanurate (TAEI), di(trimethylolpropane) tetraacrylate (Di-TMPTA), trimethylolpropane propoxylate triacrylate, trimethylolpropane trimethacrylate, pentaerythritol triacrylate, dipentaerythritol hexaacrylate, and a combination thereof.

10. The electrolyte composition of claim 1, wherein the monomer has a concentration of 0.01 wt % to 50.0 wt % in the electrolyte composition.

11. The electrolyte composition of claim 1, wherein the electrolyte composition does not include any gas-generating initiators.

12. The electrolyte composition of claim 1, wherein the electrolyte salt is selected from the group consisting of lithium perchlorate (LiClO₄), lithium nitrate (LiNO₃), lithium hexafluorophosphate (LiPF₆), lithium borofluoride (LiBF₄), lithium hexafluoroarsenide (LiAsF₆), lithium trifluoromethanesulfonate (LiCF₃SO₃), lithium bis(perfluoroethanesulfonyl)imide (LiBETI), lithium bis(fluorosulfonyl)imide (LiFSI), lithium bis(trifluoromethanesulfonyl)imide (LiN(CF₃SO₂)₂, LiTFSI), lithium bis(oxalato)borate (LiBOB), lithium difluoro(oxalato)borate (LiDFOB), lithium fluoroalkylphosphates (Li[PFₓ(C_{y}F_{2y+1-z}H_{z})₆₋ₓ]) (1≤x≤5, 1≤y≤8, and 0≤z≤2y−1), lithium fluorophosphate (Li₂PO₃F), lithium difluorophosphate (LiDFP), lithium difluoro(bisoxalato)phosphate (LiC₄PO₈F₂), lithium tetrafluoro oxalato phosphate (LiC₂PO₄F₄), lithium tris(trifluoromethanesulfonyl)methide (LiC(CF₃SO₂)₃), LiF, LiCl, LiBr, LiI, Li₂SO₄, Li₃PO₄, Li₂CO₃, LiOH, lithium acetate, lithium trifluoromethyl acetate, lithium oxalate, and a mixture thereof.

13. The electrolyte composition of claim 1, wherein the electrolyte salt has a concentration in a range from 10 wt % to 80 wt % in the electrolyte composition.

14. The electrolyte composition of claim 1, further comprising an electrolyte solvent, wherein the electrolyte solvent is selected from the group consisting of diethyl ether, dimethoxy methane, diethoxy methane, dimethoxy ethane, 1,2-diethoxyethane, 1,1-diethoxyethane, 1,1-dipropoxyethane, 1,2-dipropoxyethane, diethylene glycol, 2-(2-ethoxyethoxy)ethanol, diethylene glycol dimethyl ether, diethylene glycol diethyl ether, diethylene glycol dibutyl ether, triethylene glycol, triethylene glycol monomethyl ether, triethylene glycol monoethyl ether, triethylene glycol monobutyl ether, triethylene glycol dimethyl ether, triethylene glycol diethyl ether, triethylene glycol dibutyl ether, tetraethylene glycol, tetraethylene glycol monomethyl ether, tetraethylene glycol monoethyl ether, tetraethylene glycol monobutyl ether, tetraethylene glycol dimethyl ether, tetraethylene glycol diethyl ether, tetraethylene glycol dibutyl ether, tetrahydrofuran, dioxolane, tetrahydropyran, 1,4-dioxane, 1,3-dioxane, ethylene carbonate, diethyl carbonate, dimethyl carbonate, ethyl methyl carbonate, propylene carbonate, fluoroethylene carbonate, vinylene carbonate, succinonitrile, glutaronitrile, hexanenitrile, malononitrile, dimethyl sulfoxide, 1,3-propane sultone, sulfolane, dimethyl sulfone, ethyl methyl sulfone, ethyl vinyl sulfone, vinyl sulfone, methyl vinyl sulfone, phenyl vinyl sulfone, N-propyl-N-methylpyrrolidinium bis(fluorosulfonyl)imide, N-butyl-N-methylpyrrolidinium bis(fluorosulfonyl)imide, N-propyl-N-methylpiperidinium bis(fluorosulfonyl)imide, 1-methyl-1-(2-methoxyethyl)pyrrolidinium bis(fluorosulfonyl)imide, 1-ethyl-3-methylimidazolium bis(fluorosulfonyl)imide, trimethyl phosphate, triethyl phosphate, poly(ethylene oxide), and a combination thereof.

15. The electrolyte composition of claim 14, wherein the electrolyte solvent has a concentration in a range from 5 wt % to 85 wt % in the electrolyte composition.

16. A polymer electrolyte comprising the electrolyte composition of claim 1, wherein the monomer in the electrolyte composition has been polymerized into a polymer, and the polymer electrolyte contains visible bubbles with a volume percentage of no more than 5% of the polymer electrolyte.

17. An electrochemical device comprising the polymer electrolyte of claim 16.

18. The electrochemical device of claim 17, wherein the electrochemical device has a cycle life of at least 7.5% higher than that of an electrochemical device comprising a polymer electrolyte polymerized with a gas-generating initiator.

19. A method for preparing a polymer electrolyte, comprising:
1) mixing an electrolyte salt, a monomer and an initiator into a mixture; and
2) polymerizing the mixture, transforming the monomer in the mixture into a polymer, wherein the initiator does not generate gas during polymerization of the monomer, and wherein upon polymerizing the polymer electrolyte contains visible bubbles with a volume percentage of no more than 5% of the polymer electrolyte.

20. The method of claim 19, wherein the polymer electrolyte has no visible bubbles.
